(19) United States
(12) Patent Application Publication
(10) Pub. No.: US 2005/0071668 A1
(43) Pub. Date: Mar. 31, 2005

(54) Method, apparatus and system for monitoring and verifying software during runtime

(76) Inventors: Jeonghee M. Yoon, Portland, OR (US); David M. Durham, Hillsboro, OR (US)

Correspondence Address: INTEL CORPORATION, P.O. BOX 5326, SANTA CLARA, CA, 95056-5326, US

(21) Appl. No.: 10/677,025

(22) Filed: Sep. 30, 2003

(51) Int. Cl. G06F 11/30

(52) U.S. Cl. 713/200

(57) ABSTRACT

A method, apparatus and system monitor and verify software during runtime on a data processing device. According to embodiments of the invention, a monitoring module on an auxiliary system independent of the data processing device may monitor software during runtime on the data processing device. The monitoring module may utilize a variety of information to verify the integrity of the software running on the data processing system. In one embodiment, software signatures, checksums and image sizes may be used to verify that the software has not be tampered with and/or altered. In addition and/or alternatively, the software configuration data and/or packet statistics may be used to verify the software. In one embodiment, a remote device may be used to manage and configure the auxiliary system.

### FIELD

The present invention relates to computer security, and, more particularly, a method, apparatus and system for verifying and monitoring software during execution or “runtime”.

### BACKGROUND

Computer security is becoming increasingly important, especially in corporate environments where security breaches may cause significant damage in terms of down time, loss of data, theft of data, etc. Various technologies have been developed to protect computers from security breaches to varying degrees of success. These protection measures, however, are themselves susceptible to attacks and may be compromised by those who are sufficiently knowledgeable about the technology used.

Thus, for example, personal firewall software may be used to protect a computer from unauthorized access to and from the network. A technically savvy user and/or rogue software may, however, easily disable the firewall software and/or change its configurations to allow access to computer resources otherwise unauthorized by the user and/or system administrator. Additionally, existing technologies for identifying protecting computers are typically software-based solutions that rely on monitoring the files residing on the computer's hard disk. These software-based technologies are themselves susceptible to attack, however, since their files reside on the same computer system that may be compromised.

### BRIEF DESCRIPTION OF THE DRAWINGS

The present invention is illustrated by way of example and not limitation in the figures of the accompanying drawings in which like references indicate similar elements, and in which:

FIG. 1 illustrates conceptually an embodiment of the present invention;

FIG. 2 illustrates a system according to an embodiment of the present invention; and

FIG. 3 is a flow chart illustrating the software image verification process according to an embodiment of the invention

FIG. 4 illustrates an example of the monitoring module monitoring and verifying associated configuration data for firewall software; and

FIG. 5 s a flow chart illustrating the configuration and/or packet statistics verification process according to an embodiment of the invention.

### DETAILED DESCRIPTION

Embodiments of the present invention provide a method, apparatus and system for system monitoring and verification. Reference in the specification to “one embodiment” or “an embodiment” of the present invention means that a particular feature, structure or characteristic described in connection with the embodiment is included in at least one embodiment of the present invention. Thus, the phrases “in one embodiment”, “according to one embodiment” or the like appearing in various places throughout the specification are not necessarily all referring to the same embodiment.

According to one embodiment of the present invention, software may be monitored and verified at runtime, and corrective actions may be taken if the software is found to be compromised in any way. Thus, in contrast to existing technologies that typically monitor software files on a computer's hard disk, embodiments of the present invention may monitor and verify the software upon execution, i.e., at “runtime”. Additionally, in order to alleviate the likelihood of the monitoring and verification mechanism itself being tampered with, an embodiment of the present invention may be implemented using the processing capability of an auxiliary processor. For the purposes of this specification, an auxiliary processor shall include any processor other than the host processor of the computer being monitored and verified. Thus, for example, the auxiliary processor may include a secondary processor on a personal computer (“PC”) motherboard and/or a coprocessor running on a device coupled to the computer (e.g., a Network Interface Card (“NIC”) and/or any other bus mastering device having a processor).

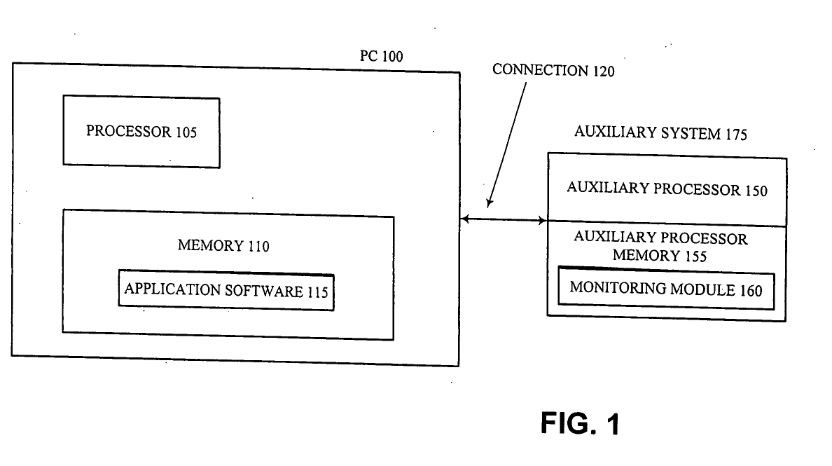

FIG. 1 illustrates conceptually an embodiment of the invention. It will be readily apparent to those of ordinary skill in the art that for simplicity, only certain components of PC 100 and Auxiliary System 175 have been included in the figure and that various other components have been omitted. Embodiments of the invention are not, however, limited by this illustration and instead various modifications and changes may be made thereto without departing from the broader spirit and scope of embodiments of the invention, as set forth in the appended claims. As illustrated, PC 100 may include Processor 105 and Memory 110, and in one embodiment of the present invention, Application Software 115 may be loaded into Memory 110 during execution or “runtime”. For the purposes of this specification, Application Software 115 may include any software running on PC 100, including the operating system, applications, and/or firewall software. Additionally, as illustrated, PC 100 may be coupled to Auxiliary System 175 via Connection 120. Auxiliary System 175 may include Auxiliary Processor 150 and Auxiliary Memory 155, and Monitoring Module 160 may be loaded into Auxiliary Memory 155. Although the present example assumes that Monitoring Module 160 is embodied in software, it will be readily apparent to those of ordinary skill in the art that Monitoring Module 160 may be implemented in hardware, software, firmware and/or a combination thereof.

Auxiliary System 175 may reside within PC 100 and/or separate from PC 100 without departing from the spirit of embodiments of the present invention. For example, Auxiliary System 175 may comprise an intelligent network interface controller coupled to PC 100. The concept of “intelligent network interface controllers” is well known to those of ordinary skill in the art and typically includes network interface controllers with a processor independent of the host processor running on PC 100. An example of an intelligent network interface controller includes NICs manufactured by Intel™ Corporation. In an alternative embodiment, Auxiliary System 175 may reside on the motherboard on PC 100. In yet another embodiment, Auxiliary System 175 may include a virtual machine executing on PC 100. As is typical with virtual machines, Auxiliary System 175 may therefore reside on PC 100, but may be effectively isolated from other components on PC 100, e.g., Processor 105 and/or Memory 110. Virtual machines systems are well known to those of ordinary skill in the art and further description thereof is omitted herein in order not to unnecessarily obscure embodiments of the present invention.

Regardless of where Auxiliary System 175 resides and/or how it is implemented, the system may be coupled to PC 100 via Connection 120, which may include a bus mastering Direct Memory Access (hereafter “DMA access”) connection such as a Peripheral Component Interconnect (“PCI”) bus. In other words, in one embodiment, Auxiliary System 175 may be coupled to PC 100 via any connection having DMA access into Memory 110 on PC 100. It will be readily apparent to those of ordinary skill in the art based on the information provided herein that Auxiliary System 175 requires only “read” DMA access into Memory 110, and in one embodiment, Auxiliary System 175 has no “write” ability into Memory 110, i.e., Auxiliary System 175 may not write to and/or affect Memory 110. In an alternate embodiment, Auxiliary System 175 may have read and write access to Memory 110.

According to an embodiment of the present invention, Monitoring Module 160, in conjunction with Auxiliary Processor 150, may monitor and verify Software 115 on PC 100 during runtime, i.e., while Application Software 115 is loaded into Memory 110. Since the monitoring and verification processes are performed by an independent system (i.e., Auxiliary System 175) rather than on Processor 105 on PC 100, the processes are completely isolated from the operating system running on PC 100. These monitoring and verification processes are therefore invisible to the PC user and/or to Application Software 115 running on PC 100. The invisibility and isolation according to embodiments of the present invention minimize the potential for compromises on PC 100 via attacks on Monitoring Module 160.

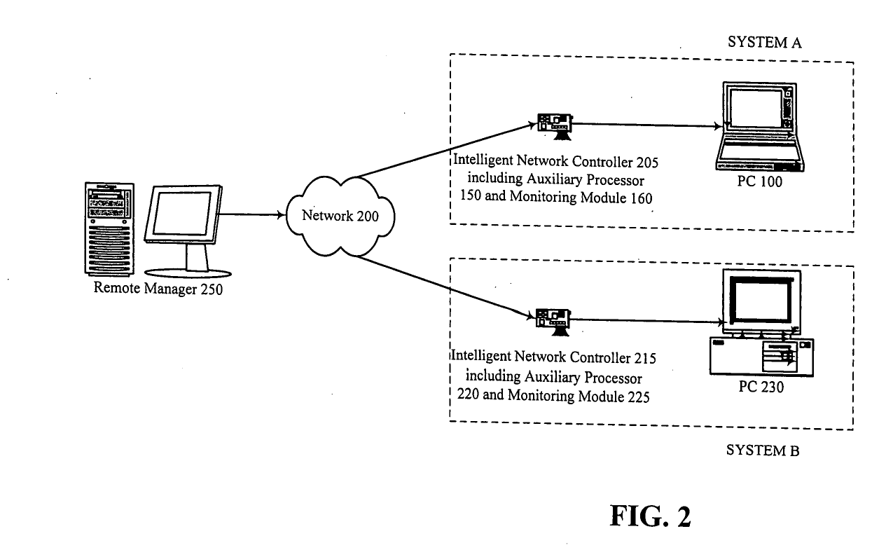

In one embodiment, Monitoring Module 160 may obtain appropriate “baseline” information to monitor and/or verify Application Software 115 on PC 100. This baseline information may include information such as the software image size, checksum of the software image, and hidden signatures that are embedded at strategic locations in the software image. In one embodiment, baseline information may be generated when Application Software 115 is initially installed on PC 100, prior to any possibility of corruption. In one embodiment, a system administrator may provide the baseline information manually to Monitoring Module 160 upon installation of Application Software 115. Thereafter, Monitoring Module 160 may utilize this baseline information to verify the Application Software 115 against the information it obtains during runtime from Memory 110. To perform verification, Monitoring Module 160 may compare the information (e.g., software image size, checksum and/or hidden signatures in the software image) against the same information previously obtained for Application Software 115. Details of how this comparison may be performed will be readily apparent to those of ordinary skill in the art and further description of such is therefore omitted herein in order not to unnecessarily obscure embodiments of the present invention. In an alternate embodiment, the baseline information may be generated on a remote processing device (e.g., Remote Manager 250 illustrated in FIG. 2 below) without departing from the spirit of embodiments of the present invention. In this embodiment, the remote processing device may provide the baseline information to Monitoring Module 160 for use during verification.

In one embodiment of the present invention, Monitoring Module 160 may be configured by Auxiliary Processor 150. According to this embodiment, Monitoring Module 160 may include and/or have access to all the necessary monitoring logic to perform the validation on its own, i.e., Auxiliary System 175 may have sufficient processing power, memory and/or other system resources to perform the validation within Auxiliary System 175. In this embodiment, Monitoring Module 160 may perform the validation and take appropriate action to block access to PC 100 if Application 115 is deemed to be altered. In an alternate embodiment, however, Monitoring Module 160 may comprise only primitive logic (e.g., Auxiliary Processor 150 may be a simple processor and Auxiliary System 175 may have minimal memory), and the configuration and management of Monitoring Module 160 may be performed by a remote process. According to this embodiment, Monitoring Module 160 may access Memory 110 to obtain the appropriate memory block for Application 115 and send the information correlating to this memory block to the remote process for comparison against the baseline information. Alternatively, Monitoring Module 160 may perform the comparison within Auxiliary System 175 and send the results to the remote process. In this embodiment, the remote process may determine the appropriate action to be taken in the case of a mismatch of information.

FIG. 2 illustrates a system according to an embodiment of the present invention wherein a remote process (hereafter “Remote Manager 250”) may interact with Monitoring Module 160 to provide remote configuration and management of the monitoring process. Although the example assumes that Auxiliary System 175 is an intelligent network interface controller, it will be readily apparent to those of ordinary skill in the art that any other independent processing system may be utilized. Additionally, although Remote Manager 250 is illustrated as residing on a remote device, it will be readily apparent to those of ordinary skill in the art that Remote Manager 250 may reside on PC 100 (e.g., Remote Manager 250 may be a process running on a virtual machine on PC 100).

Thus, as illustrated in FIG. 2, auxiliary processors may reside on intelligent network interface controllers coupled to PCs. In one embodiment, in System A, Intelligent Network Controller 205 may be coupled to PC 100, and may include Auxiliary Processor 150 and Monitoring Software 210. Similarly, in System B, Intelligent Network Controller 215 may be coupled to PC 230, and may include Auxiliary Processor 220 and Monitoring Software 225. Both systems may be coupled to Remote Manger 250 via Network 200. Although the following example discusses an embodiment of the present invention with respect to System A, it will be readily apparent to those of ordinary skill in the art that the discussion is equally applicable to System B.

In one embodiment, Intelligent Network Controller 205 may be coupled to PC 100 via a PCI bus or other such connection providing DMA access to Memory 110 on PC 100. Intelligent NICs are well known to those of ordinary skill in the art and typically include a basic interface to Network 200 and a coprocessor that has the ability to run software independently from the host processor. Network 200 may comprise any type of network and Remote Manager 250 may communicate over Network 200 with Intelligent Network Controller 205 via any communications protocol supported by Network 200. The methods by which Intelligent Network Controller 205 and Remote Manager 250 may communicate with each other are well known to those of ordinary skill in the art and description of such is omitted herein in order not to unnecessarily obscure embodiments of the present invention. Additionally, although Remote Manager 250 is depicted as residing on a separate device from the intelligent NIC, in one embodiment, the functionality of the remote manager may in fact be adapted for implementation on Intelligent Network Controller 205 and/or Intelligent Network Controller 215. In yet another alternate embodiment, Remote Manager 250 may reside on PC 100 (e.g., within a virtual machine executing on PC 100).

In one embodiment, Remote Manager 250 may configure Monitoring Software 160 with all the information necessary to perform monitoring and verification. Thus, for example, Remote Manager 250 may provide Monitoring Software 160 with baseline information pertaining to Application Software 115, and Monitoring Software 160 may be configured to retrieve memory blocks from Memory 110 on PC 100 to verify the integrity of Application Software 115 and its associated configuration information. In one embodiment, Monitoring Software 160 may be configured to perform these scans at predetermined intervals, while in an alternate embodiment, these scans may be random and/or determined dynamically by Monitoring Software 160. Remote Manager 250 may also configure Monitoring Software 160 to take predetermined actions if Application Software 115 and/or its configuration data is compromised. For example, Monitoring Software 160 may generate an alert to Remote Manager 250, and/or Monitoring Software 160 may immediately restrict PC 100's access to Network 200. Alternatively, Monitoring Software 160 may simply provide all the necessary information to Remote Manager 250 and Remote Manager 250 may determine the appropriate predetermined actions. It will be readily apparent to those of ordinary skill in the art that the predetermined actions may be customized to suit the needs of the user, network administrator and/or organization.

Application Software 115 on PC 100 may be compromised several ways. For example, Application Software 115 may be prevented from running altogether if the user uninstalls the software, changes the operating systems settings to disable the software, if the software is corrupted and/or if component file(s) are missing. While the user's actions may be seemingly acceptable (i.e., the user changes the configuration on his own machine), within a corporate environment, this type of behavior may cause the system administrator to be unable to properly administer PC 100. Alternatively or in addition, Application Software 115 and/or its configuration may be infected by a computer worm and/or virus or modified by an unauthorized user (e.g., a hacker) to alter the software's behavior. Application Software 115 may also be circumvented entirely. For example, typical firewall software running on Microsoft Windows™ operating systems may be implemented as an intermediate driver. To circumvent the firewall software, an unauthorized user may create a set of intermediate drivers that are installed above and/or below the firewall software to bypass the firewall software altogether. In this example, the circumvention may disable the security on PC 100, and expose PC 100 to a variety of unauthorized entities.

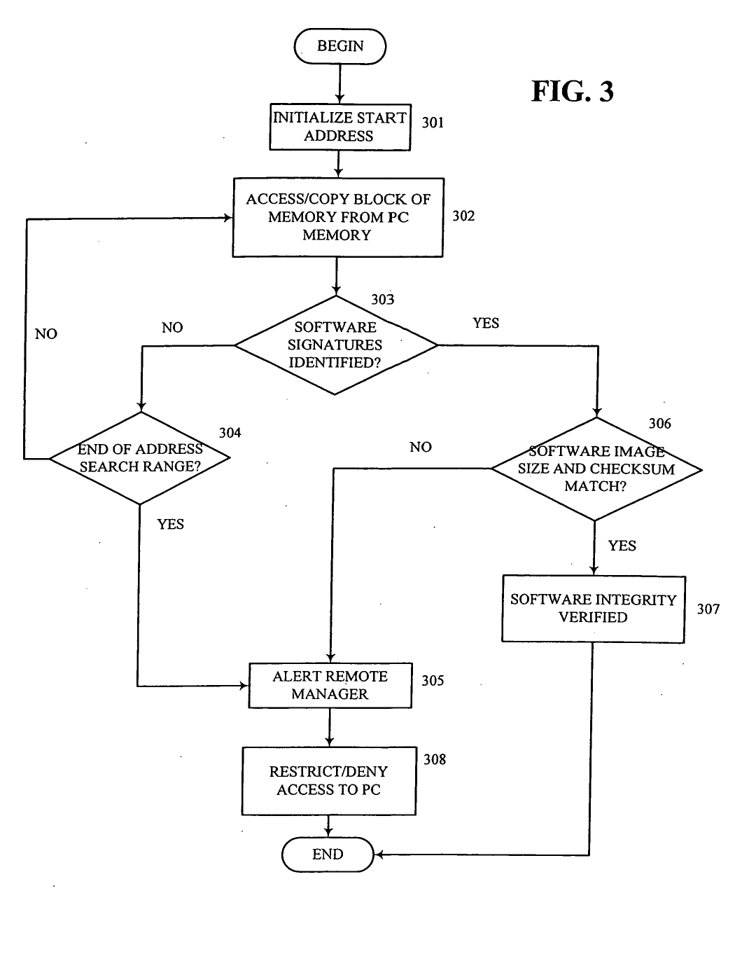

Embodiments of the present invention may detect one or more of the scenarios described above. FIG. 3 is a flow chart illustrating the software image verification process according to an embodiment of the invention. Although the following operations may be described as a sequential process, many of the operations may in fact be performed in parallel or concurrently. In addition, the order of the operations may be re-arranged without departing from the spirit of embodiments of the invention. According to this embodiment, Monitoring Module 160 may monitor and validate the runtime image of Application Software 115 in Memory 110. This embodiment may address at least the problems that arise when Application Software 115 is prevented from running and/or when it is infected and/or altered by unauthorized users and/or processes.

The software verification process may begin, as illustrated in FIG. 3, in 301 wherein the starting address of the search range may be initialized. In 302, Monitoring Module 160 may access a block of Memory 110 on PC 100 and/or create a copy of this block in Auxiliary Memory 155. In other words, Monitoring Module 160 may be configured to copy memory blocks into Auxiliary Memory 155 and/or in an alternate embodiment, Module 160 (having DMA access to Memory 110) may simply read the contents of Memory 110 without copying the contents to Auxiliary Memory 155. In 303, the block of memory may be examined to identify “signatures” corresponding to the software being monitored. A signature may include, for example, any data pattern (e.g., data size, time stamp, etc.) capable of uniquely identifying the software. If Monitoring Module 160 does not find the software signature it is looking for at the current address, it may increment the address in 304 and continue searching for the signature until it reaches the end of the block. If the signature is not found within the block, then Monitoring Module 160 may access an additional block of Memory 110 in 302 and/or create a copy of this additional block in Auxiliary Memory 155.

The process in 302-304 may be repeated until Monitoring Module 160 reaches the end of the search range, i.e., it has examined all relevant areas of Memory 110 without finding the expected software signature. If so, in 305, Monitoring Module 160 may be configured to alert Remote Manager 250 that Application Software 115 may be invalid and/or not running on PC 100. Remote Manager 250 may then restrict and/or deny network access to PC 100 in 308. In an alternate embodiment, Monitoring Module 160 may be configured to itself restrict access to PC 100, with or without sending an alert to Remote Manager 250. As previously described, Monitoring Module 160 may be configured in a variety of ways to handle any indications that Application Software 115 has been tampered with and/or altered.

If a software signature is identified in 303, on the other hand, Monitoring Module 160 may proceed to verify the software using the software size, checksum (CRC) and/or other more sophisticated one-way hashing mechanisms such as MD5 and/or SHA1. MD5 and SHA1 are well known to those of ordinary skill in the art and further description thereof is omitted herein in order not to unnecessarily obscure embodiments of the present invention. Any reference hereafter to size and/or checksums may therefore include other one-way hashing mechanisms such as MD5 and/or SHA1 without departing from the spirit of embodiments of the present invention. In 306, the software image size, checksum and/or other attribute values (depending on the mechanism selected to perform the verification) may be compared against the baseline values. If these values match, then in 307, Application Software 115 is deemed to be verified, i.e., the software has not been tampered with and/or changed. If, however, the software image size, checksum and/or other attribute values do not match the expected values, in 305, Monitoring Module 160 may be configured to alert Remote Manager 250 that Application Software 115 may be invalid and/or not running on PC 100. Remote Manager 250 may then restrict and/or deny network access to PC 100 in 308. In an alternate embodiment, Monitoring Module 160 may provide the software signature to Remote Manager 250 and Remote Manager 250 may compare the software image size and checksums against the baseline information. As previously described, Monitoring Module 160 and/or Remote Manager 250 may be configured in a variety of other ways to handle any indications that Application Software 115 has been tampered with and/or changed without departing from the spirit of embodiments of the present invention.

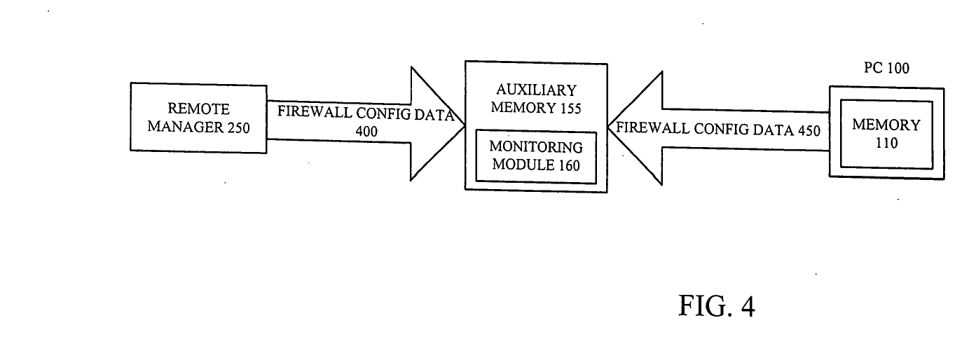

In an alternate embodiment, instead of and/or in addition to monitoring and verifying Application Software 115, the configuration data associated with Application Software 115 may also be monitored and verified. In this embodiment, the configuration data may be accessible from Memory 110, i.e., Application Software loads its configuration information into Memory 110. FIG. 4 illustrates an example of Monitoring Module 160 monitoring and verifying associated configuration data for Application Software 115 (illustrated as Firewall Software 125). According to this embodiment, Monitoring Module 160 may obtain Firewall Configuration Data 400 from Remote Manager 250. In alternate embodiments, Monitoring Module 160 may obtain Firewall Configuration Data 400 from other sources.

As illustrated, Monitoring Module 160 may obtain a baseline a copy of Firewall Configuration Data 400 and compare this data against Firewall Configuration Data 450 from Memory 110 on PC 100. If Firewall Configuration Data 400 matches Firewall Configuration Data 450, Monitoring Module 160 may deem Firewall Configuration Data 450 unchanged, thus indicating that Firewall Configuration Data 450 has not been tampered with and/or altered. If, however, the data does not match, Monitoring Module 160 may alert Remote Manager 250 and/or restrict network access to PC 100. Alternatively, Remote Manager 250 may restrict network access to PC 100. Thus, this embodiment provides an additional layer of protection for Firewall Software 425 by ensuring that Firewall Configuration Data 450 is also secure and unaltered.

Additionally, as described above, certain types of software (such as firewall software) may be implemented as intermediate drivers. To circumvent this type of software, an unauthorized user may create a set of intermediate drivers that are installed above and/or below the software to bypass the software altogether. According to an embodiment, in order to address this problem and further increase security on PC 100, packet statistics (such as packet counts, byte counts, etc.) may be tracked and compared. More specifically, Intelligent Network Controller 205 may maintain statistics for PC 100 and Monitoring Software 160 may maintain and/or obtain its own statistics. These statistics may be compared against each other and if the statistics do not match, Monitoring Software 160 may be configured to interpret this mismatch as a sign that Application Software 115 has been circumvented. It will be readily apparent to those of ordinary skill in the art that this embodiment utilizes the functionality of an intelligent network controller and/or other similar device capable of keeping track of packets transmitted on the network.

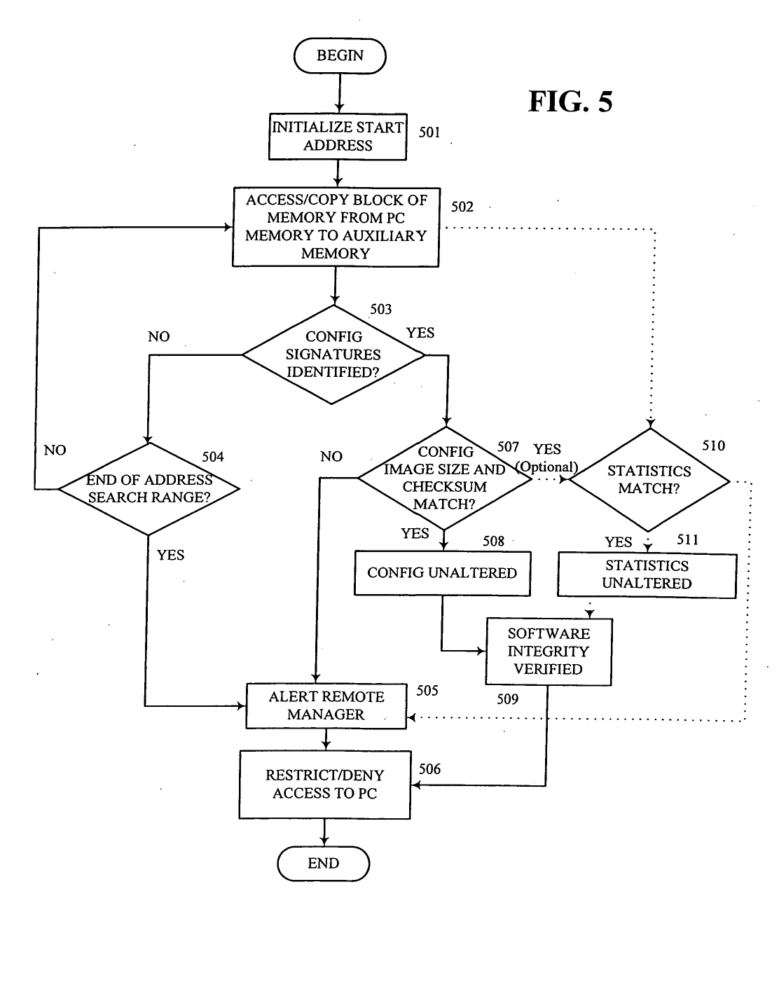

FIG. 5 is a flowchart illustrating the configuration and/or packet statistics monitoring and verification described above. Although the following operations may be described as a sequential process, many of the operations may in fact be performed in parallel or concurrently. In addition, the order of the operations may be re-arranged without departing from the spirit of embodiments of the invention. According to this embodiment, Monitoring Module 160 may monitor and validate the runtime image of configuration data corresponding to Application Software 115 in Memory 110 and/or statistics maintained by PC 100 relative to Application Software 115 during runtime.

The software verification process may begin, as illustrated in FIG. 5, in 501 wherein the starting address of the search range may be initialized. In 502, Monitoring Module 160 may access a block of Memory 110 on PC 100 and create a copy of this block in Auxiliary Memory 155. In 503, the block of memory may be examined to identify signatures corresponding to the configuration data being monitored. If Monitoring Module 160 does not find the configuration data signature it is looking for at the current address, it may increment the address in 504 and continue searching for the signature within the block. If the signature is not found within the block, Monitoring Module 160 may access an additional block of Memory 110 in 502 and create a copy of this additional block in Auxiliary Memory 155.

The process in 502-504 may be repeated until Monitoring Module 160 reaches the end of the search range, i.e., it has examined all relevant areas of Memory 110 without finding the expected configuration data signature. If so, in 505, Monitoring Module 160 may be configured to alert Remote Manager 250 of the configuration data mismatch, possibly indicating that Application Software 115 may be invalid and/or not running on PC 100. Remote Manager 250 may then restrict and/or deny network access to PC 100 in 506. In an alternate embodiment, Monitoring Module 160 may be configured to itself restrict access to PC 100, with and/or without sending an alert to Remote Manager 250. As previously described, Monitoring Module 160 may be configured in a variety of ways to handle any indications that Application Software 115 has been tampered with and/or altered.

If a configuration data signature is identified in 503, on the other hand, Monitoring Module 160 may proceed to verify the configuration data. In 507, the configuration data image size and checksum may be compared against the values previously obtained by Monitoring Module 160. If these values match, in 508 Monitoring Module 160 may deem the configuration data for Application Software 115 is unaltered, and in 509, the integrity of Application Software 115 may verified. Alternatively and/or in addition, Monitoring Module 160 may compare the packet statistics tracked by PC 100 against the packet statistics maintained by Monitoring Module 160 in 510. If the values match, in 511, the statistics are deemed to be unaltered, and in 511, the integrity of Application Software 115 is verified.

If, however, the configuration data image size and/or checksum do not match the expected values, in 510, Monitoring Module 160 may be configured to alert Remote Manager 250 that Application Software 115 may have been tampered with and/or altered. Similarly, if the statistics from PC 100 and Monitoring Module 160 do not match, Monitoring Module 160 may be configured to alert Remote Manager 250 in 509 that Application Software 115 may have been tampered with and/or altered. In either case, Remote Manager 250 may then restrict and/or deny network access to PC 100 in 510. As previously described, Monitoring Module 160 may also be configured in a variety of other ways to handle any indications that Application Software 115 has been tampered with and/or changed without departing from the spirit of embodiments of the present invention.

In one embodiment, the processes and/or portions of the processes illustrated in FIG. 3 and/or FIG. 5 may be run periodically to ensure the ongoing health of Application Software 115 on PC 100. Additionally, or alternatively, the processes and/or portions of the processes may be triggered by a combination of various conditions and events such as a fixed time interval, the number of packets traveling through Intelligent Network Controller 205, requests by Remote Manager 250, etc. It will be readily apparent to those of ordinary skill in the art that these processes and/or portions of the processes may be activated in a variety of ways without departing from the spirit of embodiments of the present invention.

Embodiments of the present invention may be implemented on a variety of data processing devices. It will be readily apparent to those of ordinary skill in the art that these data processing devices may include various types of software, firmware and hardware. According to an embodiment of the present invention, the data processing devices may also include various components capable of executing instructions to accomplish an embodiment of the present invention. For example, the data processing devices may include and/or be coupled to at least one machine-accessible medium. As used in this specification, a “machine” includes, but is not limited to, any data processing device with one or more processors. As used in this specification, a machine-accessible medium includes any mechanism that stores and/or transmits information in any form accessible by a data processing device, the machine-accessible medium including but not limited to, recordable/non-recordable media (such as read only memory (ROM), random access memory (RAM), magnetic disk storage media, optical storage media and flash memory devices), as well as electrical, optical, acoustical or other form of propagated signals (such as carrier waves, infrared signals and digital signals).

According to an embodiment, a data processing device may include various other well-known components such as one or more processors. The processor(s) and machine-accessible media may be communicatively coupled using a bridge/memory controller, and the processor may be capable of executing instructions stored in the machine-accessible media. The bridge/memory controller may be coupled to a graphics controller, and the graphics controller may control the output of display data on a display device. Similarly, an audio adapter may be coupled to the bridge/memory controller to control the output of audio to a speaker. The bridge/memory controller may be coupled to one or more buses. A host bus controller such as a Universal Serial Bus (“USB”) host controller may be coupled to the bus(es) and a plurality of devices may be coupled to the USB. For example, user input devices such as a keyboard and mouse may be included in the data processing device for providing input data. The data processing device may additionally include a network interface (e.g., a network interface card and/or a modem) capable of coupling the device to a network.

In the foregoing specification, the invention has been described with reference to specific exemplary embodiments thereof. It will, however, be appreciated that various modifications and changes may be made thereto without departing from the broader spirit and scope of embodiments of the invention, as set forth in the appended claims. The specification and drawings are, accordingly, to be regarded in an illustrative rather than a restrictive sense.

1. A method of monitoring and verifying software on a data processing device, comprising:
an auxiliary system monitoring the software during runtime on the computer, the auxiliary system existing independently of the computer's processor and memory;
the auxiliary system searching for a compromise to the software; and
the auxiliary system restricting access to the computer if the compromise is identified.

2. The method according to claim 1 wherein the software during runtime is loaded into the computer's memory.

3. The method according to claim 1 wherein searching for the compromise to the software further comprises examining portions of the computer's memory.

4. The method according to claim 1 wherein searching for the compromise to the software further comprises copying portions of the computer's memory into a memory on the auxiliary system to identify any compromises to the software.

5. The method according to claim 1 wherein restricting access to the computer further comprises:
the auxiliary system alerting a remote system of the compromise; and
the remote system restricting access to the computer if the compromise is identified.

6. The method according to claim 1 further comprising a remote system providing the auxiliary system with information pertaining to the software.

7. The method according to claim 6 wherein providing the auxiliary system with information pertaining to the software further comprises providing the auxiliary system with baseline data for the software.

8. The method according to claim 1 wherein the auxiliary system comprises a device having direct memory access (“DMA access”) to the computer's memory.

9. The method according to claim 1 wherein the auxiliary system includes an intelligent network interface controller.

10. The method according to claim 1 wherein monitoring the software further comprises monitoring configuration data for the software.

11. The method according to claim 10 wherein the configuration data for the software is loaded during runtime into the computer's memory.

12. An article comprising a machine-accessible medium having stored thereon instructions that, when executed by a machine, cause the machine to monitor and verify software on a computer by:
monitoring the software during runtime on the computer independently of the computer's processor and memory;
searching for a compromise to the software; and
restricting access to the computer if the compromise is identified.

13. The article according to claim 12 wherein the software during runtime is loaded into the computer's memory.

14. The article according to claim 12 wherein the instructions, when executed by the machine, further cause the machine to monitor and verify the software by examining portions of the computer's memory.

15. The article according to claim 12 wherein the instructions, when executed by the machine, further cause the machine to monitor and verify the software by copying portions of the computer's memory into the machine-accessible medium.

16. The article according to claim 12 wherein the instructions, when executed by the machine, further cause the machine to monitor and verify the software by:
alerting a remote system of the compromise; and
the remote system restricting access to the computer if the compromise is identified.

17. The article according to claim 12 wherein the instructions, when executed by the machine, further cause the machine to monitor and verify the software by a remote system providing information pertaining to the software.

18. The article according to claim 17 wherein the instructions, when executed by the machine, further cause the machine to monitor and verify the software by the remote system providing baseline data for the software.

19. The article according to claim 12 wherein the instructions, when executed by the machine, further cause the machine to monitor and verify the software by monitoring configuration data for the software.

20. The article according to claim 19 wherein the configuration data for the software is loaded during runtime into the computer's memory.

21. An auxiliary processing system, comprising:
a processor;
a memory coupled to the processor; and
a monitoring module capable of accessing the processor and the memory, the monitoring module further capable of monitoring and verifying software during runtime on a computer system.

22. The auxiliary processing system according to claim 21 wherein the processor, the memory and the monitoring module are isolated from the computer system.

23. The auxiliary processing system according to claim 22 wherein the processor, memory and monitoring module reside within a virtual machine on the computer system.

24. The auxiliary processing system according to claim 22 wherein the processor, memory and monitoring module reside on a separate device from the computer system.

25. The auxiliary processing system according to claim 21 wherein the auxiliary system is capable of being coupled to a remote system.

26. The auxiliary processing system according to claim 25 wherein the remote system is capable of providing the auxiliary processing system with information pertaining to the software on the computer system.

27. The auxiliary processing system according to claim 26 wherein the remote system is further capable of providing the auxiliary processing system with baseline data for the software on the computer system.

28. The auxiliary processing system according to claim 26 wherein the remote system is further capable of providing the auxiliary processing system with configuration data for the software on the computer system.
